(19) United States
(12) Patent Application Publication
(10) Pub. No.: US 2009/0074071 A1
(43) Pub. Date: Mar. 19, 2009

(54) Apparatus and Method for Image Processing and Computer Program

(76) Inventors: Takefumi NAGUMO, Kanagawa (JP); Hideyuki ICHIHASHI, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/204,634

(22) Filed: Sep. 4, 2008

(30) Foreign Application Priority Data
Sep. 5, 2007 (JP) P2007-230053

(51) Int. Cl. H04N 7/26

(52) U.S. Cl. 375/240.16; 375/E07.123

(57) ABSTRACT

An image processing apparatus includes the following elements. A local motion vector estimation unit estimates a local motion vector associated with each of blocks, serving as segments of an image frame constituting a moving image. A block weight calculation unit calculates a block weight as an index of the reliability of a local motion vector for each block. A global motion vector estimation unit receives the local motion vectors and the weights to estimate a global motion vector as a motion vector common to the blocks in the frame. The global motion vector estimation unit calculates, as a cost, the sum of the products of the differences between the local motion vectors associated with the respective blocks and the global motion vector and the block weights assigned to the respective blocks subjected to difference calculation and calculates parameters of the global motion vector which minimize the cost.

### CROSS REFERENCES TO RELATED APPLICATIONS

The present invention contains subject matter related to Japanese Patent Application JP 2007-230053 filed in the Japanese Patent Office on Sep. 5, 2007, the entire contents of which are incorporated herein by reference.

### BACKGROUND OF THE INVENTION

1. Field of the Invention

The present invention relates to apparatuses and methods for image processing and computer programs, and in particular, relates to an image processing apparatus and method for detecting a motion vector in an image, and a computer program.

2. Description of the Related Art

In image coding, such as moving image compression, a motion vector is detected and data compression based on motion vector information is performed. According to the MPEG systems known as image coding systems, for example, a process for segmenting each frame into blocks and detecting a motion vector in each block of the current frame using a corresponding block of a reference frame is performed. However, when motion vector information in block units is contained in compressed data, the amount of data increases. When a camera is moved by, for example, a panning or tilting action or hand movement, motion vectors for respective blocks are substantially the same. In such a case, a single motion vector associated with one frame is set instead of a motion vector for each block and a coding process is performed using motion vectors obtained in this manner, so that the amount of data can be reduced.

A motion vector for each block is called a local motion vector (LMV) and a motion vector associated with one frame is called a global motion vector (GMV). Data coding using a global motion vector is utilized in, for example, the MPEG-4.

For example, it is assumed that there are two image frames, i.e., an image frame 10 captured at time t0 and an image frame 11 taken at time t1 as shown in FIG. 1A. Those two frames were captured while a camera was moved due to a panning or tilting action or hand movement. A captured image is totally shifted as shown in the figure.

To encode those images, generally, each frame is segmented into blocks each including a matrix of, for example, n×n pixels, a motion vector (MV) for each block, namely, a local motion vector is detected, and data compression and decompression are performed using motion vectors for the respective blocks. However, if the camera was moved by a panning or tilting action or hand movement, the motion vectors for the respective blocks are substantially the same as shown in FIG. 1B.

In such a case, image coding is performed using one motion vector 21 that describes the motion of the whole image as shown in FIG. 1C. Thus, the efficiency of coding can be remarkably increased. Such a vector representing the motion of the whole image is called a global motion vector.

A global motion vector can be expressed as data describing simple translation as shown in FIG. 1C, rotation, enlargement, reduction, Affine transformation, or projection transformation using a plurality of parameters. As mentioned above, coding using a global motion vector is utilized in the MPEG-4.

The MPEG-4 uses an image coding technique applying a global motion vector and using global motion compensation (GMC) as a standard. An encoder detects a global motion vector and a decoder performs decoding with global motion compensation using the received global motion vector.

A global motion vector is expressed as data describing the relationship between a pixel position at (x, y) in the current frame and a corresponding pixel position at (x′, y′) in a reference frame shown in FIG. 2 as translation, rotation, enlargement, reduction, Affine transformation, or projection transformation. Generally, a single global motion vector is assigned to one image frame. A frame may be segmented into segments each having a size larger than, for example, a normal block and a global motion vector may be set for each segment. In other words, the number of global motion vectors for each image frame is not limited to one. A single global motion vector may be set as a motion vector common to a plurality of blocks included in a single image frame and a plurality of global motion vectors may be set for the single image frame.

When a global motion vector describes, for example, only translation (parallel displacement), this vector is expressed using two parameters [a₀, a₁] as follows.

x′=x+a₀

y′=y+a₁

A global motion vector describing translation (parallel displacement) with rotation is expressed using three parameters [a₀, a₁, a₂] as follows.

x′=sin a₀x−cos a₀y+a₂

y′=cos a₀x+sin a₀y+a₁

A global motion vector describing Affine transformation is expressed using six parameters [a₀, a₁, a₂, a₃, a₄, a₅] as follows.

x′=a₀x−a₁y+a₂

y′=a₃x+a₄y+a₅

A global motion vector describing projection transformation is expressed using eight parameters [a₀, a₁, a₂, a₃, a₄, a₅, a₆, a₇] as follows.

x′=((a₀x+a₁y+a₂)/(a₆x+a₇y+1))

y′=((a₃x+a₄y+a₅)/(a₆x+a₇y+1))

To obtain a global motion vector from a moving image frame, a process using the current frame and a reference frame is performed as shown in FIG. 2. There are some techniques for obtaining a global motion vector. According to one technique, a local motion vector for each block is obtained and a global motion vector is then obtained using the local motion vectors. Such a technique is disclosed in IEEE Transactions on Consumer Electronics, Vol. 52, No. 2, May 2006.

According to this technique, a local motion vector for each block is obtained, local motion vectors having high reliability are selected from among the local motion vectors associated with the respective blocks, and a global motion vector is obtained on the basis of the selected local motion vectors having high reliability.

For example, it is assumed that p local motion vectors associated with p blocks are obtained and q local motion vectors having high reliability are selected from among the p local motion vectors. A single global motion vector is obtained on the basis of the q local motion vectors having high reliability without using the other (p-q) local motion vectors having low reliability.

As for information regarding the reliability of a local motion vector, for example, information indicating whether clear feature matching information is obtained in block matching between the current frame and a reference frame is used. As for techniques for obtaining a single global motion vector on the basis of local motion vectors having high reliability, for example, a method of least squares may be used.

Such a technique for deriving a global motion vector using local motion vectors can be performed as an extension of related-art local motion vector estimation. Advantageously, already-existing components can be used. However, when the number of local motion vectors having high reliability is small, the reliability of a global motion vector remarkably decreases.

### SUMMARY OF THE INVENTION

The present invention is made in consideration of the above-described problems. It is desirable to provide an image processing apparatus and method capable of obtaining a global motion vector using local motion vectors without remarkably reducing the reliability of the global motion vector even when the number of local motion vectors having high reliability is small, and a computer program.

According to a first embodiment of the present invention, an image processing apparatus includes the following elements. A local motion vector estimation unit estimates a motion vector associated with each of blocks, serving as segments of an image frame constituting a moving image, as a local motion vector. A block weight calculation unit calculates a block weight as an index of the reliability of a local motion vector associated with each block. A global motion vector estimation unit receives the local motion vectors and the block weights to estimate a global motion vector as a motion vector common to the blocks included in the image frame. The global motion vector estimation unit is configured to calculate, as a cost, the sum of the products of the differences between the local motion vectors associated with the respective blocks and the global motion vector and the block weights assigned to the respective blocks subjected to difference calculation, calculate configuration parameters of the global motion vector which minimize the cost, and generate the global motion vector in which the calculated parameters are set.

In this embodiment, the block weight calculation unit may be configured to obtain a plurality of block-associated weight data elements based on different data elements and calculate a block weight associated with each block on the basis of the block-associated weight data elements.

In this embodiment, the block weight calculation unit may be configured to obtain a plurality of block-associated weight data elements based on different data elements and calculate the product of the block-associated weight data elements as a block weight associated with each block.

In this embodiment, the block weight calculation unit may perform a process for calculating a block weight using at least one of values of (a) the size of a local motion vector associated with each block, (b) the sum of absolute difference associated with each block, (c) a variance of pixel values associated with each block, (d) a covariance obtained from pixel values associated with each block of a processing target frame and those associated with the corresponding block of a reference frame, (e) a correlation between a local motion vector associated with each block and those associated with blocks adjacent to the block, and (f) a correlation coefficient obtained from the pixel values associated with each block of the processing target frame and those associated with the corresponding block of the reference frame.

In this embodiment, the global motion vector estimation unit may be configured to receive the local motion vectors and the block weights and estimate a single global motion vector associated with the image frame as a motion vector common to all of the blocks included in the image frame.

According to a second embodiment of the present invention, there is provided an image processing method for executing motion vector detection in an image processing apparatus. The method includes the steps of (A) estimating a motion vector associated with each of blocks, serving as segments of an image frame constituting a moving image, as a local motion vector, (B) calculating a block weight as an index of the reliability of a local motion vector associated with each block, and (C) receiving the local motion vectors and the block weights to estimate a global motion vector as a motion vector common to the blocks included in the image frame. In step (C), the sum of the products of the differences between the local motion vectors associated with the respective blocks and the global motion vector and the block weights assigned to the respective blocks subjected to difference calculation is calculated as a cost, configuration parameters of the global motion vector which minimize the cost are calculated, and the global motion vector in which the calculated parameters are set is generated.

In this embodiment, preferably, in step (B), a plurality of block-associated weight data elements based on different data elements are obtained and a block weight associated with each block is calculated on the basis of the block-associated weight data elements.

In this embodiment, preferably, in step (B), a plurality of block-associated weight data elements based on different data elements are obtained and the product of the block-associated weight data elements is calculated as a block weight associated with each block.

In this embodiment, preferably, in step (B), a process for calculating a block weight is performed using at least one of values of (a) the size of a local motion vector associated with each block, (b) the sum of absolute difference associated with each block, (c) a variance of pixel values associated with each block, (d) a covariance obtained from pixel values associated with each block of a processing target frame and those associated with the corresponding block of a reference frame, (e) a correlation between a local motion vector associated with each block and those associated with blocks adjacent to the block, and (f) a correlation coefficient obtained from the pixel values associated with each block of the processing target frame and those associated with the corresponding block of the reference frame.

According to this embodiment, preferably, in step (C), the local motion vectors and the block weights are received and a single global motion vector associated with the image frame is estimated as a motion vector common to all of the blocks included in the image frame.

According to a third embodiment of the present invention, there is provided a computer program that allows an image processing apparatus to execute motion vector detection. The program includes the steps of (A) estimating a motion vector associated with each of blocks, serving as segments of an image frame constituting a moving image, as a local motion vector, (B) calculating a block weight as an index of the reliability of a local motion vector associated with each block, and (C) receiving the local motion vectors and the block weights to estimate a global motion vector as a motion vector common to the blocks included in the image frame. In step (C), the sum of the products of the differences between the local motion vectors associated with the respective blocks and the global motion vector and the block weights assigned to the respective blocks subjected to difference calculation is calculated as a cost, configuration parameters of the global motion vector which minimize the cost are calculated, and the global motion vector in which the calculated parameters are set is generated.

The computer program according to this embodiment of the present invention may be provided to, for example, general-purpose computer systems capable of executing various program codes from computer-readable storage media and communication media. Providing this computer program in computer-readable form achieves processing operations according to the program on such a computer system.

Other features and advantages of the present invention will become more apparent from the following more detailed description based on an embodiment of the present invention which will be described below and the accompanying drawings. The term “system” in this specification refers to a logical set of devices and the devices each serving as a component are not necessarily accommodated in a single casing.

According to an embodiment of the present invention, a local motion vector (LMV) associated with each of blocks, serving as segments of an image frame constituting a moving image, and a block weight as an index of the reliability of a local motion vector (LMV) associated with each block are obtained, and the rate of contribution of each block is set in accordance with the corresponding block weight to estimate a global motion vector (GMV). To calculate a block weight for each block, indices from various points of view, for example, the size of a local motion vector (LMV), the sum of absolute difference (SAD), a variance of pixel values of pixels constituting each block, and a covariance obtained from pixel values of pixels constituting each block in a processing target frame and those constituting the corresponding block in a reference frame are used. Advantageously, a global motion vector (GMV) having high reliability can be obtained.

### BRIEF DESCRIPTION OF THE DRAWINGS

FIGS. 1A to 1C are diagrams explaining a global motion vector;

FIG. 2 is a diagram explaining the relation between a global motion vector and points in current and reference frames, the points corresponding to each other;

FIGS. 3A and 3B are diagrams explaining the outline of a technique for deriving a global motion vector in an image processing apparatus according to an embodiment of the present invention;

FIG. 4 is a diagram illustrating the structure of a global motion vector generation mechanism set in the image processing apparatus according to the embodiment of the present invention;

FIG. 5 is a diagram explaining the detailed structure and processing of a block weight calculation unit;

FIG. 6 is a diagram explaining the structure of an LMV-based weight calculation table which an LMV-based weight calculation section uses in order to calculate an LMV-based weight;

FIG. 7A is a flowchart of a process performed by the LMV-based weight calculation section;

FIG. 7B is a diagram explaining an example of set LMV-based weights;

FIG. 8A is a flowchart of a process performed by a residual-based weight calculation section;

FIG. 8B is a diagram explaining an example of set residual-based weights;

FIG. 9A is a flowchart of a process performed by a variance-based weight calculation section;

FIG. 9B is a diagram explaining the process;

FIG. 9C is a diagram explaining an example of set variance-based weights;

FIG. 10A is a flowchart of a process performed by a covariance-based weight calculation section;

FIG. 10B is a diagram explaining the process;

FIG. 10C is a diagram explaining an example of set covariance-based weights;

FIG. 11A is a flowchart of a process for calculating a correlation-coefficient-based weight;

FIG. 11B is a diagram explaining an example of set correlation-coefficient-based weights;

FIG. 12A is a flowchart of a process performed by an LMV-correlation-based weight calculation section;

FIG. 12B is a diagram explaining the process;

FIG. 12C is a diagram explaining an example of set LMV-correlation-based weights;

FIGS. 13A and 13B are diagrams explaining a process for obtaining a global motion vector by a global motion vector estimation unit; and

FIG. 14 is a diagram showing an example of the hardware configuration of the image processing apparatus according to the embodiment of the present invention.

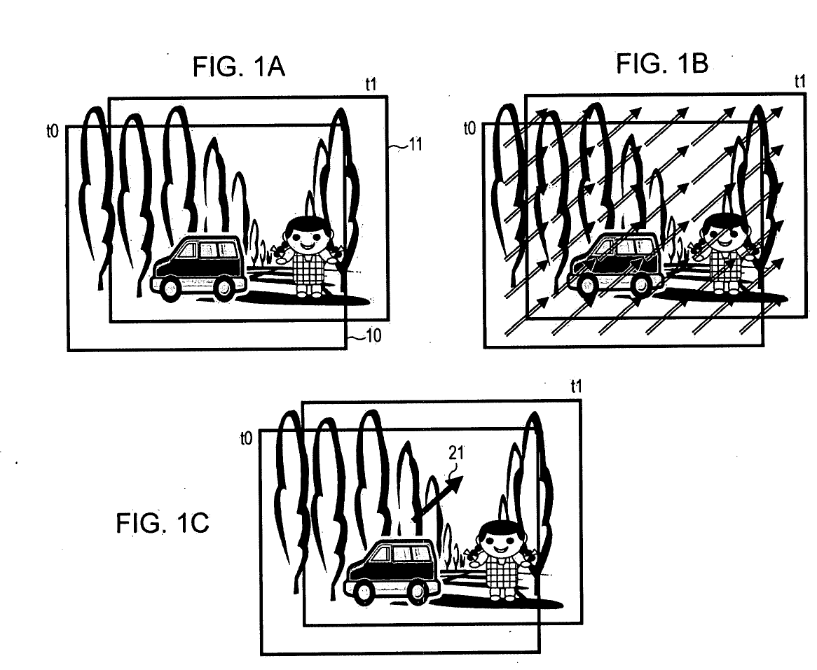

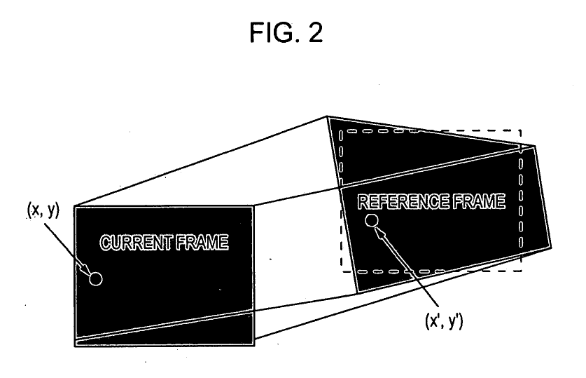

### DESCRIPTION OF THE PREFERRED EMBODIMENTS

An image processing apparatus according to an embodiment of the present invention, an image processing method therefor, and a computer program therefor will be described in detail with reference to the drawings.

The image processing apparatus according to the embodiment of the present invention inputs moving image data and performs a process for obtaining a global motion vector associated with the moving image data. Specifically, the image processing apparatus according to this embodiment first obtains a local motion vector for each block and obtains a global motion vector using the local motion vectors.

According to the present embodiment, reliability is set for each block associated with a local motion vector, a weight corresponding to the reliability is defined, and a global motion vector is obtained in consideration of the weights of the respective local motion vectors.

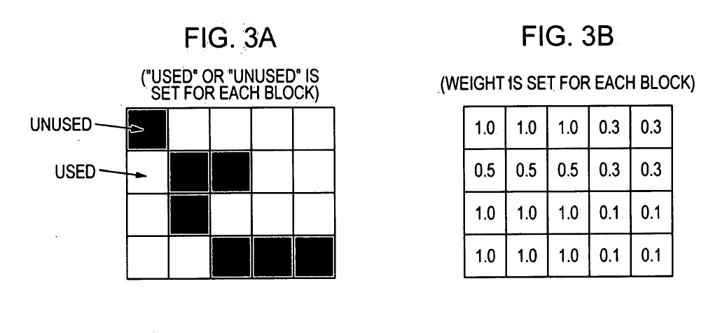

The outline of a technique for deriving a global motion vector in the image processing apparatus according to the present embodiment will now be described with reference to FIGS. 3A and 3B. FIG. 3A is a diagram explaining the above-described related-art technique and FIG. 3B is a diagram explaining the technique according to the embodiment of the present invention.

According to the technique shown in FIG. 3A, p local motion vectors associated with p blocks obtained by segmenting one image frame are obtained, q local motion vectors having high reliability are selected from among the p local motion vectors, and a single global motion vector is obtained on the basis of the q local motion vectors having high reliability without using the other (p-q) local motion vectors having low reliability. As for information indicating the reliability of a local motion vector, information indicating whether clear feature matching information is obtained in block matching between, for example, the current frame and a reference frame is used. As for a technique for obtaining a single global motion vector on the basis of local motion vectors having high reliability, for example, the method of least squares is used.

This technique for obtaining a global motion vector using local motion vectors can be performed as an extension of related-art local motion vector estimation. Advantageously, already-existing components can be used. However, when the number of local motion vectors having high reliability is small, the reliability of a global motion vector remarkably decreases.

According to the technique in accordance with the embodiment of the present invention shown in FIG. 3B, n local motion vectors associated with n blocks obtained by segmenting one image frame are obtained and a weight corresponding to the reliability is set for each block. After that, a global motion vector is obtained in consideration of the weights of the respective local motion vectors.

A specific example of the technique in accordance with the present embodiment will now be described. When a global motion vector describes, for example, only translation (parallel displacement), the relation between coordinates (x, y) in the current frame image and corresponding coordinates (x′, y′) in a reference image is expressed using two parameters [a₀, a₁] as the following Expression 1 as described above.

x′=x+a₀

y′=y+a₁ (1)

As for any block, indicated at n, in the image frame shown in FIG. 3B, when the local motion vector [LMVₙ] describes only translation (parallel displacement) on the condition that the local motion vector [LMVₙ]=(MVXₙ, MVYₙ), the relation between coordinates (xₙ, yₙ) of the block [n] in the current frame image and coordinates (uₙ, vₙ) of the corresponding block [n] in a reference image is expressed by the following Expression 2.

uₙ=xₙ+MVXₙ

vₙ=yₙ+MVYₙ (2)

When the number of blocks is, for example, p, the relational expressions associated with the p local motion vectors [LMV]=(MVXₙ, MVYₙ) are set.

The difference [eₙ] between a global motion vector associated with one image frame and the local motion vector [LMVₙ] of the block [n] included in the frame is defined as the following Expression 3.

eₙ={square root over ((uₙ−(a₀+xₙ))²+(vₙ−(a₁+yₙ))²)} (3)

A global motion vector cost (GMV cost) [Q] is calculated using the vector difference [eₙ] associated with each block [n] and a weight [wₙ] set for the block [n] in accordance with the following Expression 4.

Q=Σwₙeₙ (4)

Two parameters [a₀, a₁] that minimize the GMV cost [Q] calculated by the above Expression 4 are obtained. The obtained parameters [a₀, a₁] are used to determine the above-described global motion vector expressed as follows by the foregoing Expression 1:

x′=x+a₀

y′=y+a₁.

As for the process of obtaining the parameters [a₀, a₁] that minimize the cost [Q] in accordance with the above Expressions 3 and 4, the process uses the method of least squares based on weights associated with respective blocks.

In the above-described process example, the global motion vector describes only translation (parallel displacement) and two parameters [a₀, a₁] are obtained. As described above, a global motion vector may be set as information containing translation, rotation, enlargement, reduction, Affine transformation, or projection transformation. The number of parameters varies in accordance with setting. In this case, the difference [eₙ] between the global motion vector associated with a frame and the local motion vector [LMVₙ] of each block [n] included in the frame is obtained in a manner similar to the above process, parameters [a₀, a₁, a₂, a₃, . . . ] that minimize the GMV cost [Q] on the basis of weights associated with the respective blocks are obtained, and the global motion vector is determined using the parameters.

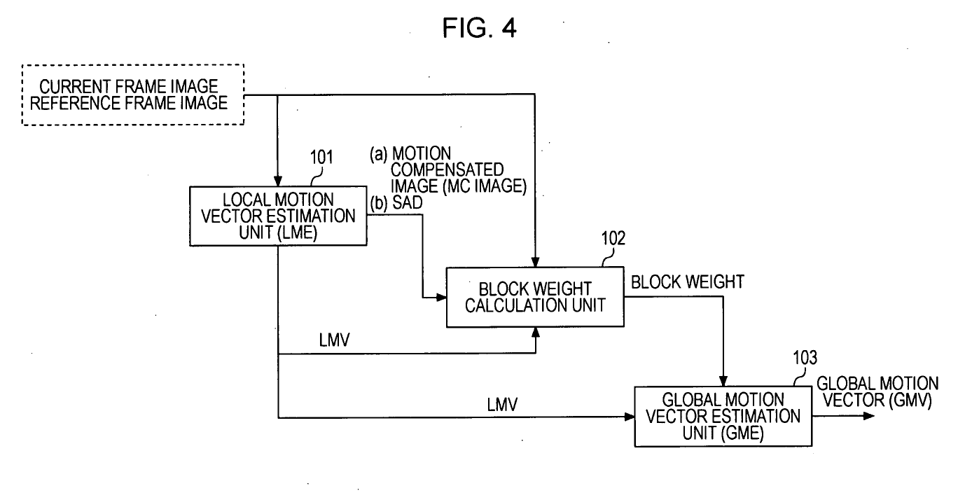

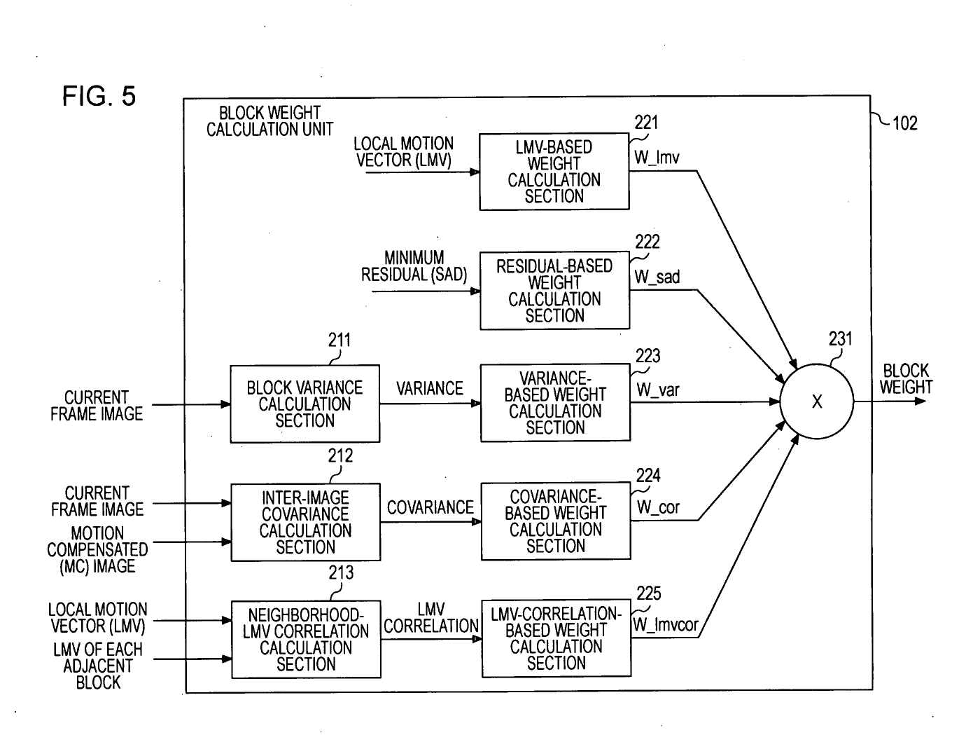

The process for obtaining a global motion vector according to the embodiment of the present invention will now be described in detail with reference to FIGS. 4 and 5. FIG. 4 illustrates the structure of a global motion vector (GMV) generation mechanism set in the image processing apparatus according to this embodiment. The current frame image and a reference frame image are input and a global motion vector is output.

The global motion vector generation mechanism set in the image processing apparatus according to this embodiment includes a local motion vector estimation unit (LME) 101, a block weight calculation unit 102, and a global motion vector estimation unit (GME) 103 as shown in FIG. 4.

The local motion vector estimation unit 101 receives the current frame image and a reference frame image to estimate a motion vector associated with each of blocks obtained by segmenting one frame, i.e., a local motion vector (LMV). As for a process used in the local motion vector estimation unit 101, a well-known process, for example, block matching is used to estimate a local motion vector associated with each block.

Each local motion vector obtained by the local motion vector estimation unit 101 is input to the block weight calculation unit 102 and the global motion vector estimation unit 103.

In addition, a motion compensated image subjected to motion compensation (MC) and a minimum residual (SAD: sum of absolute difference) are supplied to the block weight calculation unit 102. The motion compensated (MC) image is generated upon estimating a local motion vector in the local motion vector estimation unit 101. The minimum residual (SAD) serves as the sum of the absolute values of the differences between pixel information elements related to a block in the current image frame and those related to a corresponding block in the reference image frame.

The block weight calculation unit 102 calculates a weight for each block set in the current frame. The detailed structure and process of the block weight calculation unit 102 will now be described with reference to FIG. 5.

Referring to FIG. 5, the block weight calculation unit 102 includes a block variance calculation section 211, an inter-image covariance calculation section 212, and a neighborhood-LMV correlation calculation section 213. The block weight calculation unit 102 further includes the following components:

(a) LMV-based weight calculation section 211;

(b) residual-based weight calculation section 222;

(c) variance-based weight calculation section 223;

(d) covariance-based weight calculation section 224; and

(e) LMV-correlation-based weight calculation section 225.

The block weight calculation unit 102 further includes a multiplication section 231.

According to this embodiment, the block weight calculation unit 102 is configured to calculate block weights based on five different data elements obtained by the above-mentioned sections (a) to (e) and multiply those five different block weights to obtain a final block weight. Processes for obtaining the block weights based on the five different data elements obtained by the above sections (a) to (e) will now be sequentially described below.

### (a) LMV-Based Weight Calculation Section 221

The LMV-based weight calculation section 211 receives a local motion vector (LMV) associated with each block from the local motion vector estimation unit (LME) 101 shown in FIG. 4 to calculate a weight based on the received local motion vector.

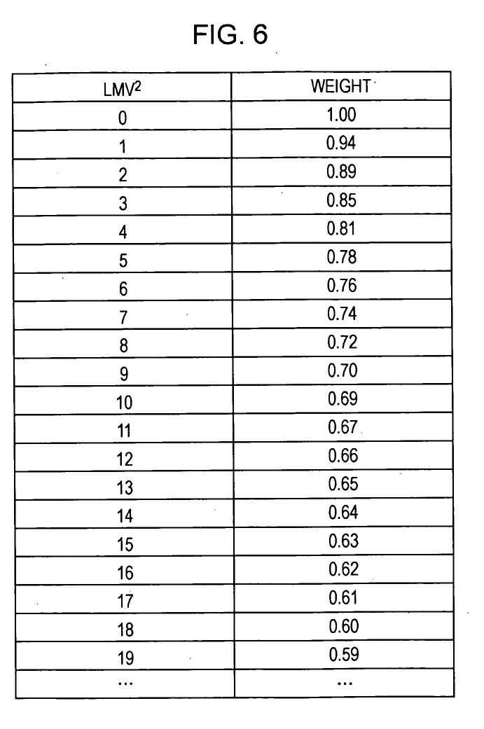

The LMV-based weight calculation section 211 holds an LMV-based weight calculation table and calculates an LMV-based weight in accordance with the table. FIG. 6 illustrates the structure of the LMV-based weight calculation table. The table of FIG. 6 contains values [LMV²], each of which is calculated on the basis of the scalar of a local motion vector, and corresponding data elements each representing an LMV-based weight.

In the present process example, the value [LMV²] is obtained as follows.

LMV²=LMVx²+LMVy²

LMVx represents an x component of a local motion vector (LMV) and LMVy represents a y component thereof.

Weights set in the LMV-based weight calculation table shown in FIG. 6 range from 1.0 to 0.0. A maximum weight is [1.0]. This table is an example. Weights may be set in the range from 0.0 to 1.0. For example, weights may be set in the range from 0.5 to 1.0 k.

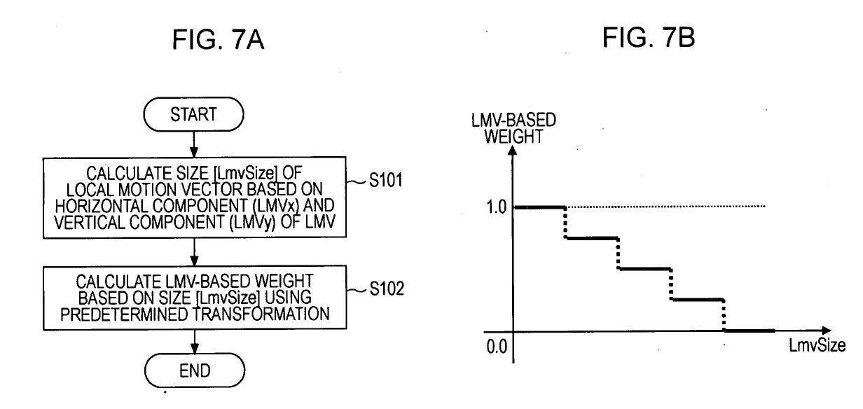

The LMV-based weight calculation section 211 may be configured to calculate an LMV-based weight in accordance with a flowchart shown in FIG. 7A. First, in step S101, the size [LmvSize] of a local motion vector (LMV) associated with each block received from the local motion vector estimation unit 101 shown in FIG. 4 is calculated on the basis of a horizontal component (LMVx) and a vertical component (LMVy) of the local motion vector. The size [LmvSize] of the local motion vector is calculated by the following Expression 5.

LmvSize=\sqrt{LMVx²+LMVy²} (5)

Subsequently, in step S102, an LMV-based weight is calculated on the basis of the size [LmvSize] of the local motion vector obtained in step S101 in accordance with a predetermined transformation. For example, a weight is calculated by transformation in accordance with a transformation table shown in FIG. 7B.

The LMV-based weight obtained as described above is set as shown in FIG. 7B such that the smaller the size [LmvSize] of the local motion vector, the larger the LMV-based weight, and the larger the size [LmvSize] of the local motion vector, the smaller the LMV-based weight. In the set example of FIG. 7B, the weight changes depending on the size [LmvSize] of the local motion vector in a stepwise manner.

### (b) Residual-Based Weight Calculation Section 222

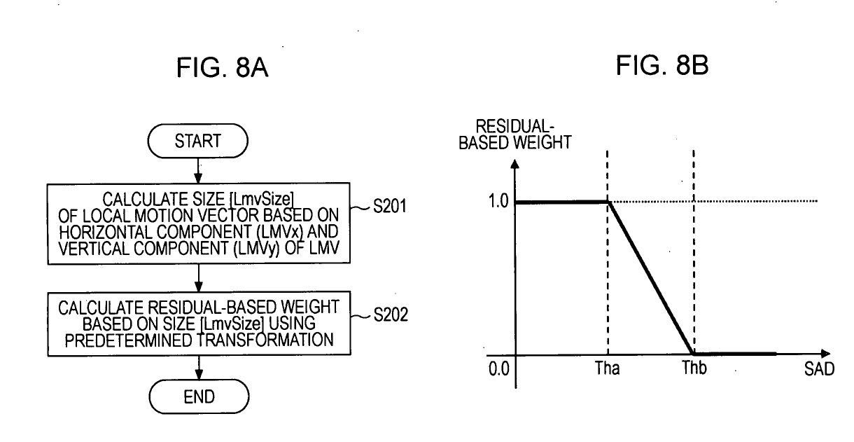

The residual-based weight calculation section 222 receives a minimum residual (SAD) associated with each block from the local motion vector estimation unit 101 shown in FIG. 4 to calculate a weight based on the minimum residual (SAD). This process will now be described with reference to FIGS. 8A and 8B.

FIG. 8A is a flowchart explaining a processing sequence for calculating a weight (hereinafter, “residual-based weight”) based on a minimum residual (SAD) on the basis of the minimum residual in the residual-based weight calculation section 222. FIG. 8B illustrates an example of the relation between the minimum residual (SAD) and the residual-based weight.

As described above, a minimum residual (SAD) is the sum of the absolute values of the differences between pixel information elements related to a block in the current image frame and those related to a corresponding block in the reference frame. The residual-based weight calculation section 222 performs the process according to the flowchart of FIG. 8A on the basis of a minimum residual (SAD) associated with each block supplied from the local motion vector estimation unit 101 shown in FIG. 4 to calculate a residual-based weight.

First, in step S201, the size [LmvSize] of a local motion vector (LMV) associated with each block supplied from the local motion vector estimation unit 101 shown in FIG. 4 is calculated on the basis of a horizontal component (LMVx) and a vertical component (LMVy) of the local motion vector. The size [LmvSize] of the local motion vector is calculated by the foregoing Expression 5.

Subsequently, in step S202, a residual-based weight is calculated on the basis of the size [LmvSize] of the local motion vector calculated in step S201 by a predetermined transformation. For example, the weight is calculated by transformation in accordance with a transformation table shown in FIG. 8B.

The residual-based weight obtained as described above is set as shown in FIG. 8B such that the smaller the minimum residual (SAD), the larger the weight, and the larger the minimum residual (SAD), the smaller the weight. In the example of FIG. 8B, a maximum weight of 1.0 is assigned to a minimum residual (SAD) of a predetermined value [Tha] or less and a minimum weight of 0.0 is assigned to a minimum residual (SAD) of a predetermined value [Thb] or more.

### (c) Variance-Based Weight Calculation Section 223

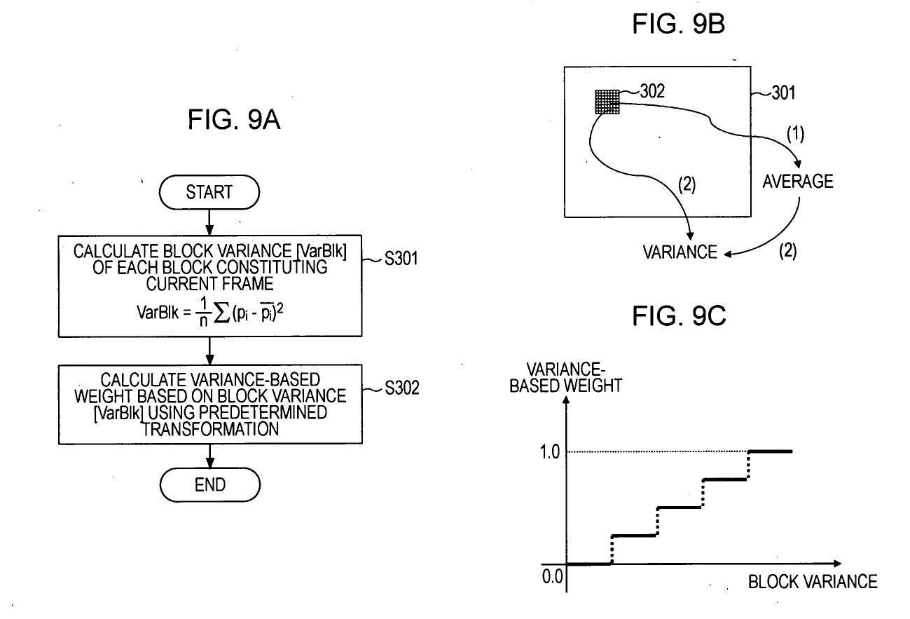

The variance-based weight calculation section 223 receives a block variance associated with each block of the current frame from the block variance calculation section 211 to calculate a weight (hereinafter, a variance-based weight) based on the block variance. This process will now be described with reference to FIGS. 9A to 9C.

FIG. 9A is a flowchart explaining a processing sequence for calculating a variance-based weight, the processing sequence being performed by the block variance calculation section 211 and the variance-based weight calculation section 223. FIG. 9B is a diagram explaining a process of calculating a block variance in the block variance calculation section 211. FIG. 9C is a diagram illustrating the relation between the block variance and the variance-based weight.

First, step S301 of the flowchart in FIG. 9A corresponds to processing by the block variance calculation section 211. In step S301, the current frame image is input and a block variance [VarBlk] associated with each block of the current frame image is calculated. The block variance [VarBlk] is calculated in accordance with the following Expression 6:

$$VarBlk = \frac{1}{n} \sum {( {p}_{i} - \overline{{p}_{i}} )}^{2} \qquad ( 6 )$$

where pi represents an ith pixel value in the block, overbarred pi represents an average of pixel values in the block, and n represents the number of pixels in the block.

FIG. 9B is a diagram explaining the processing in step S301, i.e., the process for calculating a block variance in the block variance calculation section 211. Referring to FIG. 9B, a pixel value [pi] in a processing target block 302 of a current frame 301 and an average pixel value [overbarred pi] of the pixels in this block are obtained, and a block variance [VarBlk] is calculated in accordance with the above-described Expression 6.

Processing in step S302 corresponds to a process performed by the variance-based weight calculation section 223. The variance-based weight calculation section 223 receives the block variance [VarBlk], obtained in step S301 by the block variance calculation section 211, and calculates a variance-based weight on the basis of the block variance [VarBlk] by a predetermined transformation. For example, weight calculation is performed by transformation in accordance with a transformation table shown in FIG. 9C.

The variance-based weight calculated in this manner is set as shown in FIG. 9C such that the smaller the block variance, the smaller the weight, and the larger the block variance, the larger the weight. In the example shown in FIG. 9C, the weight changes depending on the block variance [VarBlk] in a stepwise manner.

### (d) Covariance-Based Weight Calculation Section 224

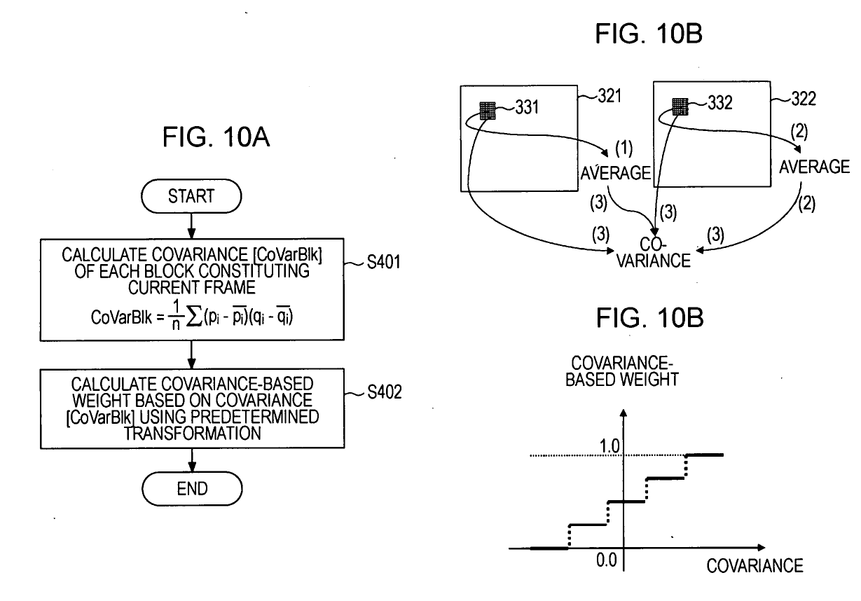

The covariance-based weight calculation section 224 receives a covariance, obtained by analyzing a block in the current frame and a corresponding block in a motion compensated (MC) image, from the inter-image covariance calculation section 212 to calculate a covariance-based weight. This process will now be described with reference to FIGS. 10A, 10B, and 10C.

FIG. 10A is a flowchart explaining a processing sequence for calculating a covariance-based weight, the processing sequence being performed by the inter-image covariance calculation section 212 and the covariance-based weight calculation section 224. FIG. 10B is a diagram explaining a process for calculating a covariance in the inter-image covariance calculation section 212. FIG. 10C is a diagram illustrating the relation between the covariance and the covariance-based weight.

First, step S401 in the flowchart of FIG. 10A corresponds to the process by the inter-image covariance calculation section 212. According to this process, the current frame image and a motion compensated (MC) reference frame image are input and a covariance [CoVarBlk] associated with each block in the current frame image is calculated. The covariance [CoVarBlk] is calculated by the following procedure. The process will now be described with reference to FIG. 10B.

First, an average [overbarred pi] of pixel values [pi] in a processing target block 331 in a current frame image 321 is calculated.

Subsequently, an average [overbarred qi] of pixel values [qi] in a corresponding block 332 in a motion-compensated reference image (MC image) 322 is calculated.

A covariance is obtained on the basis of those calculated values in accordance with the following Expression 7:

$$CoVarBlk = \frac{1}{n} \sum ( {p}_{i} - \overline{{p}_{i}} ) ( {q}_{i} - \overline{{q}_{i}} ) \qquad ( 7 )$$

where pi represents an ith pixel value in the block of the current frame, overbarred pi represents an average of pixel values in the block of the current frame, qi denotes an ith pixel value in the corresponding block in the motion-compensated reference image (MC image), overbarred qi represents an average of pixel values in the corresponding block of the motion-compensated reference image (MC image), and n represents the number of pixels in each block.

Step S402 corresponds to processing by the covariance-based weight calculation section 224. The covariance-based weight calculation section 224 receives the covariance [CoVarBlk], obtained in step S401 by the inter-image covariance calculation section 212, and calculates a covariance-based weight on the basis of the covariance [CoVarBlk] in accordance with a predetermined transformation. For example, weight calculation is performed by transformation in accordance with a transformation table shown in FIG. 10C.

The covariance-based weight calculated in this manner is set as shown in, for example, FIG. 10C such that the smaller the covariance, the smaller the weight, and the larger the covariance, the larger the weight. In the example shown in FIG. 10C, the weight changes depending on the covariance [CoVarBlk] in a stepwise manner.

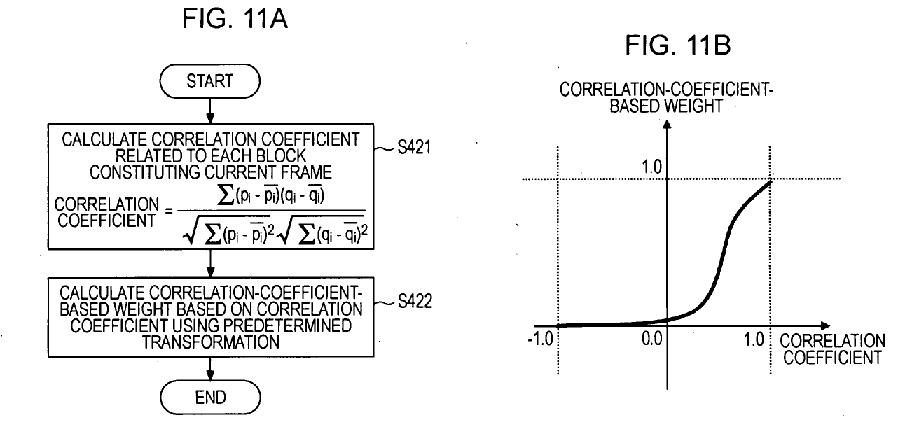

In the above-described process, a covariance is determined and a covariance-based weight is calculated on the basis of the covariance using the transformation. Alternatively, a correlation coefficient may be calculated from pixel value data related to a block constituting the current frame image and that related to a corresponding block constituting the motion-compensated (MC) reference image, and a correlation-coefficient-based weight may be calculated on the basis of the obtained correlation coefficient. This process will now be described with reference to FIGS. 11A and 11B.

FIG. 11A is a flowchart explaining a processing sequence for calculating a correlation coefficient from pixel value data related to each block constituting the current frame image and that related to the corresponding block constituting a motion-compensated (MC) reference frame image and calculating a correlation-coefficient-based weight on the basis of the obtained correlation coefficient. FIG. 11B is a diagram illustrating the relation between the correlation coefficient and the correlation-coefficient-based weight.

First, in step S421 of the flowchart shown in FIG. 11A, the current frame image and the motion-compensated (MC) reference frame image are input and a correlation coefficient is calculated from data related to each block constituting the current frame image and that related to the corresponding block constituting the reference frame image in accordance with the following Expression 8:

$$Correlation Coefficient = \frac{\sum ( {p}_{i} - \overline{{p}_{i}} ) ( {q}_{i} - \overline{{q}_{i}} )}{\sqrt{\sum {( {p}_{i} - \overline{{p}_{i}} )}^{2}} \sqrt{\sum {( {q}_{i} - \overline{{q}_{i}} )}^{2}}} \qquad ( 8 )$$

where pi represents an ith pixel value in the block of the current frame, overbarred pi represents an average of pixel values in the block of the current frame, qi represents an ith pixel value in the corresponding block of the motion-compensated reference image (MC image), overbarred qi represents an average of pixel values in the corresponding block of the motion-compensated reference image (MC image), and n represents the number of pixels in each block.

In step S422, the correlation coefficient obtained in step S421 is input and a correlation-coefficient-based weight is calculated on the basis of the correlation coefficient in accordance with a predetermined transformation. For example, weight calculation is performed by transformation in accordance with a transformation table shown in FIG. 11B.

The correlation-coefficient-based weight obtained in this manner is set as shown in, for example, FIG. 11B such that the smaller the correlation coefficient, the larger the weight, and the larger the correlation coefficient, the larger the weight. In the example of FIG. 11B, the weight smoothly changes in accordance with the correlation coefficient.

### (e) LMV-Correlation-Based Weight Calculation Section 225

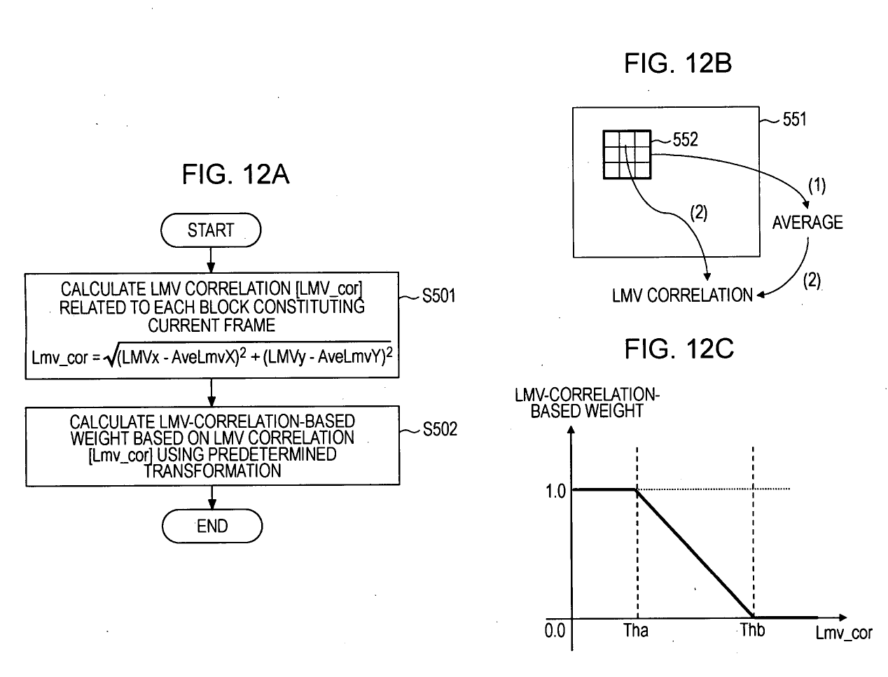

The LMV-correlation-based weight calculation section 225 receives a local motion vector (LMV) correlation associated with each block of the current frame from the neighborhood-LMV correlation calculation section 213, and calculates an LMV-correlation-based weight. This process will now be described with reference to FIGS. 12A, 12B, and 12C.

FIG. 12A is a flowchart explaining a processing sequence for calculating an LMV-correlation-based weight, the processing sequence being performed by the neighborhood-LMV correlation calculation section 213 and the LMV-correlation-based weight calculation section 225. FIG. 12B is a diagram explaining a process for calculating a correlation with a neighborhood LMV by the neighborhood-LMV correlation calculation section 213. FIG. 12C is a diagram illustrating the relation between a correlation [Lmv_cor] with a neighborhood LMV and an LMV-correlation-based weight.

Step S501 of the flowchart in FIG. 12A corresponds to the process by the neighborhood-LMV correlation calculation section 213. According to the process, a local motion vector of a processing target block in the current frame image and a local motion vector of each block adjacent to the target block are input and an LMV correlation [Lmv_cor] related to each block in the current frame image is calculated.

This process will now be described with reference to FIG. 12B. An average of pixel values of pixels in a processing target block 552 of a current frame image 551 is calculated. Subsequently, an LMV correlation [Lmv_cor] is calculated using the average and a pixel value of each pixel in the block in accordance with the following Expression 9:

$$Lmv\_cor = \sqrt{{( LMVx - AveLmvX )}^{2} + {( LMVy - AveLmvY )}^{2}} \qquad ( 9 )$$

where AveLmvX represents the average (horizontal direction) of LMVs of neighborhood blocks adjacent to the processing target block, AveLmvY represents the average (vertical direction) of the LMVs of the neighborhood blocks adjacent to the target block, LMVx represents the LMV (horizontal direction) of the target block, and LMVy represents the LMV (vertical direction) of the target block.

Step S502 corresponds to processing by the LMV-correlation-based weight calculation section 225. According to this process, the LMV correlation [Lmv_cor] obtained in step S501 by the neighborhood-LMV correlation calculation section 213 is input and an LMV-correlation-based weight is calculated on the basis of the LMV correlation [Lmv_cor] using a predetermined transformation. For example, weight calculation is performed by transformation in accordance with a transformation table shown in FIG. 12C.

The LMV-correlation-based weight obtained in this manner is set as shown in FIG. 12C such that the smaller the LMV correlation, the larger the weight, and the larger the LMV correlation, the smaller the weight. In the example shown in FIG. 12C, a maximum weight of 1.0 is set for an LMV correlation of a predetermined value [Tha] or less and a minimum weight of 0.0 is set for an LMV correlation of a predetermined value [Thb] or more.

The processes performed by the block weight calculation unit 102 in the global motion vector generation mechanism shown in FIG. 4 have been described. In other words, the processes performed by those weight calculation sections shown in FIG. 5, i.e., (a) the LMV-based weight calculation section 211, (b) the residual-based weight calculation section 222, (c) the variance-based weight calculation section 223 (and the block variance calculation section 211), (d) the covariance-based weight calculation section 224 (and the inter-image covariance calculation section 212), and (e) the LMV-correlation-based weight calculation section 225 (and the neighborhood-LMV correlation calculation section 213) have been explained.

In the block weight calculation unit 102, as shown in FIG. 5, those different block-associated weight data elements (a) to (e) are supplied to the multiplication section 231 to calculate a final block weight and the block weight is output to the global motion vector estimation unit 103 shown in FIG. 4.

When let [W_lmv] denote an LMV-based weight calculated by (a) the LMV-based weight calculation section 211, let [W_sad] be a residual-based weight calculated by (b) the residual-based weight calculation section 222, let [W_var] denote a variance-based weight obtained by (c) the variance-based weight calculation section 223, let [W_cor] be a covariance-based weight calculated by (d) the covariance-based weight calculation section 224, and let [W_lmvcor] denote an LMV-covariance-based weight obtained by (e) the LMV-correlation-based weight calculation section 225, the multiplication section 231 receives those weights to calculate a block weight [W_block] in accordance with the following Expression 10.

W_block=W_{—}lmv×W_{—}sad×W_{—}var×W_{—}cor×W_{—}lmvcor (10)

Again referring to FIG. 4, the global motion vector estimation unit 103 receives the block weight [W_block] obtained by the block weight calculation unit 102 and the local motion vector associated with each block calculated by the local motion vector estimation unit 101, and calculates a global motion vector associated with the frame on the basis of the received data elements.

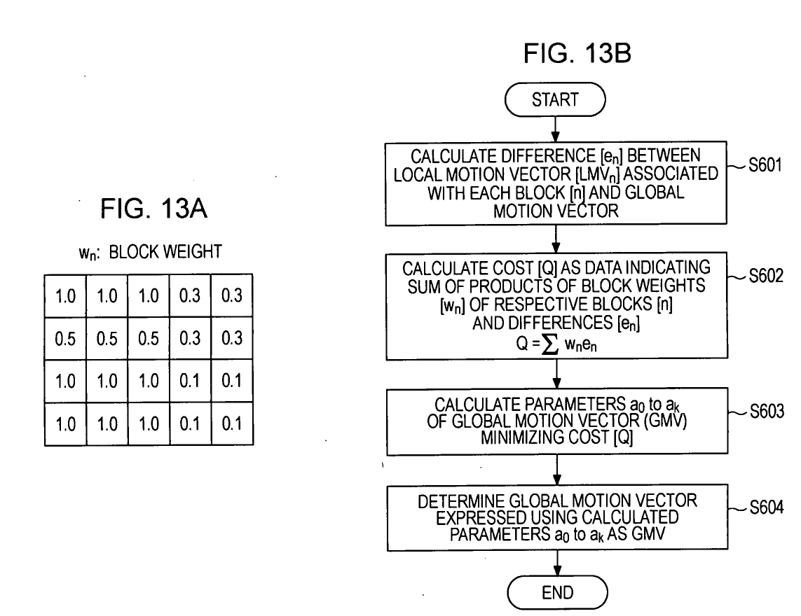

The process for calculating a global motion vector in the global motion vector estimation unit 103 will now be described with reference to FIGS. 13A and 13B.

The global motion vector estimation unit 103 receives data regarding block weights [W_block] calculated by the block weight calculation unit 102, for example, data shown in FIG. 13A. The data indicates the result of calculation of weights associated with the respective blocks on the basis of the above-described different weight data elements associated with the respective blocks, serving as small areas set in one frame. In other words, a weight assigned to each block is calculated using an LMV-based weight [W_lmv] calculated by (a) the LMV-based weight calculation section 211, a residual-based weight [W_sad] obtained by (b) the residual-based weight calculation section 222, a variance-based weight [W_var] calculated by (c) the variance-based weight calculation section 223, a covariance-based weight [W_cor] calculated by (d) the covariance-based weight calculation section 224, and an LMV-correlation-based weight [W_lmvcor] calculated by (e) the LMV-correlation-based weight calculation section 225 in accordance with the following expression:

W_block=W_{—}lmv×W_{—}sad×W_{—}var×W_{—}cor×W_{—}lmvcor.

The global motion vector estimation unit 103 further receives local motion vectors associated with the respective blocks obtained by the local motion vector estimation unit 101 in addition to the block weights shown in FIG. 13A, and obtains a global motion vector in consideration of the weights of the respective local motion vectors.

The process performed by the global motion vector estimation unit 103 will now be described with reference to a flowchart shown in FIG. 13B. For example, it is assumed that each of a global motion vector and a local motion vector associated with each block is a vector describing only translation (parallel displacement).

Initially, in step S601, the difference [eₙ] between a local motion vector [LMVₙ] associated with each block [n] constituting a processing target frame and a global motion vector is calculated.

In the case where a global motion vector describes, for example, only translation (parallel displacement), the relation between coordinates (x, y) in the current frame image and coordinates (x′, y′) in a reference image is expressed using two parameters [a₀, a₁] as the following expression, as described above.

x′=x+a₀

y′=y+a₁

When a local motion vector [LMVₙ] associated with each block represents only translation (parallel displacement) and the local motion vector [LMVₙ] is expressed as [LMVₙ]=(MVXₙ, MVYₙ), the relation between coordinates (xₙ, yₙ) of the block [n] in the current frame image and coordinates (uₙ, vₙ) of the corresponding block [n] in the reference image is expressed by the following expression.

uₙ=xₙ+MVXₙ

vₙ=yₙ+MVYₙ

The difference [eₙ] between a global motion vector associated with one image frame and a local motion vector [LMVₙ] of a block [n] included in the frame is expressed by the following Expression 11, as described above.

eₙ={square root over ((uₙ−(a₀+xₙ))²+(vₙ−(a₁+yₙ))²)} (11)

In step S602, a cost [Q] serving as the data indicating the sum of the products of the block weights [wₙ] for the blocks [n] and the differences [eₙ] is calculated. In other words, a global motion vector cost (GMV cost) [Q] is calculated using the vector difference [eₙ] associated with each block [n] obtained by the above-described Expression 11 and a weight set in association with each block [n] in accordance with the following Expression 12.

Q=Σwₙeₙ (12)

Subsequently, in step S603, parameters a₀ to aₖ that minimize the GMV cost [Q] obtained by the above-described Expression 12 are calculated. In this example, the global motion vector represents only translation (parallel displacement) and is expressed as the following expression using the two parameters a₀ and a₁.

x′=x+a₀

y′=y+a₁

Since the global motion vector is expressed by the above expression using those two parameters a₀ and a₁, the two parameters a₀ and a₁ that minimize the GMV cost [Q] obtained by Expression 12 are obtained.

Finally, in step S604, the global motion vector expressed using the obtained parameters a₀ to aₖ is determined as a global motion vector associated with a processing target frame. When the vector describes only translation (parallel displacement), the global motion vector is determined using the two parameters a₀ and a₁ that minimize the GMV cost [Q] in accordance with the following expression.

x′=x+a₀

y′=y+a₁

As described above, the process for calculating the parameters a₀ and a₁ that minimize the cost [Q] in accordance with the foregoing Expressions 11 and 12 utilizes the method of least squares with consideration of weights assigned to respective blocks. The above-described process example relates to the case where the global motion vector is a vector describing only translation (parallel displacement) and the two parameters a₀ and a₁ are obtained in accordance with the process. As described above, a global motion vector may be set as information containing translation, rotation, enlargement, reduction, Affine transformation, or projection transformation. The number of parameters is varied depending on setting. In this case, the difference [eₙ] between a global motion vector associated with a frame and a local motion vector [LMVₙ] associated with each block [n] included in the frame is calculated, parameters [a₀, a₁, a₂, a₃, . . . ] that minimize the GMV cost [Q] in consideration of weights for respective blocks are calculated, and the global motion vector is determined using the calculated parameters.

As described above, the image processing apparatus according to the embodiment of the present invention is configured to calculate a block weight corresponding to the reliability of a local motion vector associated with each block, set the rate of contribution of the local motion vector associated with each block in accordance with the corresponding block weight, and determine a global motion vector. Accordingly, the global motion vector having high reliability that surely reflects the reliabilities of the local motion vectors associated with the respective blocks can be determined.

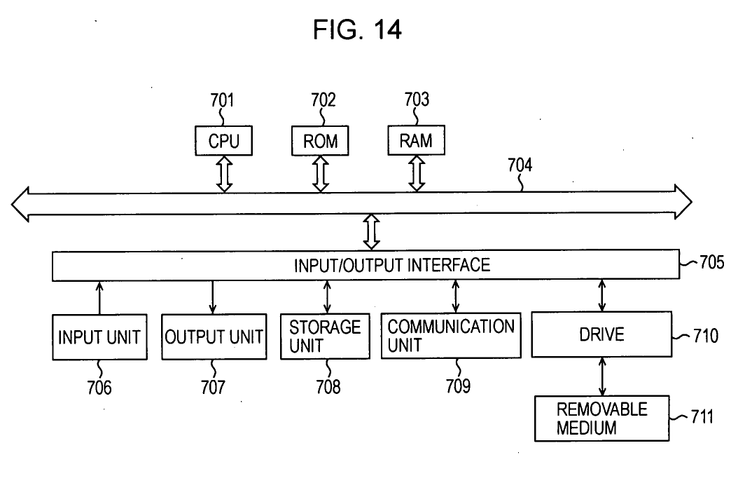

The hardware configuration of a personal computer will now be described as an example of the hardware configuration of the apparatus for performing the above-described processes with reference to FIG. 14. A central processing unit (CPU) 701 performs various processes in accordance with programs stored in a read only memory (ROM) 702 or a storage unit 708. For example, the CPU 701 performs a program for determining a global motion vector explained in the above-described embodiment. A random access memory (RAM) 703 adequately stores a program performed by the CPU 701 and data. The CPU 701, the ROM 702, and the RAM 703 are connected to a bus 704 such that those components are connected to one another.

The CPU 701 is connected to an input/output interface 705 through the bus 704. The input/output interface 705 is connected to an input unit 706 and an output unit 707. The input unit 706 includes a keyboard, a mouse, and a microphone. The output unit 707 includes a display and a speaker. The CPU 701 performs various processes in accordance with instructions supplied from the input unit 706 and outputs the results of processing to, for example, the output unit 707.

The storage unit 708, connected to the input/output interface 705, includes, for example, a hard disk and stores a program performed by the CPU 701 and various pieces of data. A communication unit 709 communicates with an external device via a network, such as the Internet or a local area network.

A drive 710, connected to the input/output interface 705, drives a removable medium 711, such as a magnetic disk, an optical disk, a magneto-optical disk, or a semiconductor memory, and obtains a program or data recorded on the medium. The obtained program or data is transferred and stored to the storage unit 708 as necessary.

The invention has been described in detail with reference to the specific embodiments. However, it is obvious that those skilled in the art can make modifications and/or substitutions of the embodiments without departing from the scope and sprit of the invention. That is, the embodiments of the present invention have been described for illustrative purpose only, and the contents of the specification should not be interpreted restrictively. To understand the scope of the invention, the appended claims should be taken into consideration.

The series of processes explained in this specification can be executed by hardware, software, or any combination thereof. When the series of processes is executed by software, a program including the processing sequences may be installed into a memory in a computer incorporated in dedicated hardware and be executed. Alternatively, the program may be installed into a multi-purpose computer capable of executing various functions and be executed. For example, the program may be prestored on a recording medium. The program may be installed from the recording medium to the computer. Alternatively, the computer may receive the program via a network, such as a local area network (LAN) or the Internet, and install the program onto a recording medium, such as a built-in hard disk.

The various processes described in this specification may be performed not only in a time-series manner as described herein but also in parallel or separately in accordance with the processing performance of an apparatus, which executes the processes, or as necessary. The term “system” in this specification is a logical set of devices and the devices each serving as a component are not necessarily accommodated in a single casing.

What is claimed is:

1. An image processing apparatus comprising:
a local motion vector estimation unit that estimates a motion vector associated with each of blocks, serving as segments of an image frame constituting a moving image, as a local motion vector;
a block weight calculation unit that calculates a block weight as an index of the reliability of a local motion vector associated with each block; and
a global motion vector estimation unit that receives the local motion vectors and the block weights to estimate a global motion vector as a motion vector common to the blocks included in the image frame, wherein
the global motion vector estimation unit is configured to calculate, as a cost, the sum of the products of the differences between the local motion vectors associated with the respective blocks and the global motion vector and the block weights assigned to the respective blocks subjected to difference calculation, calculate configuration parameters of the global motion vector which minimize the cost, and generate the global motion vector in which the calculated parameters are set.

2. The apparatus according to claim 1, wherein the block weight calculation unit is configured to obtain a plurality of block-associated weight data elements based on different data elements and calculate a block weight associated with each block on the basis of the block-associated weight data elements.

3. The apparatus according to claim 1, wherein the block weight calculation unit is configured to obtain a plurality of block-associated weight data elements based on different data elements and calculate the product of the block-associated weight data elements as a block weight associated with each block.

4. The apparatus according to claim 1, wherein
the block weight calculation unit performs a process for calculating a block weight using at least one of the following values:
(a) the size of a local motion vector associated with each block;
(b) the sum of absolute difference associated with each block;
(c) a variance of pixel values associated with each block;
(d) a covariance obtained from pixel values associated with each block of a processing target frame and those associated with the corresponding block of a reference frame;
(e) a correlation between a local motion vector associated with each block and those associated with blocks adjacent to the block; and
(f) a correlation coefficient obtained from the pixel values associated with each block of the processing target frame and those associated with the corresponding block of the reference frame.

5. The apparatus according to claim 1, wherein the global motion vector estimation unit is configured to receive the local motion vectors and the block weights and estimate a single global motion vector associated with the image frame as a motion vector common to all of the blocks included in the image frame.

6. An image processing method for executing motion vector detection in an image processing apparatus, the method comprising the steps of:
(A) estimating a motion vector associated with each of blocks, serving as segments of an image frame constituting a moving image, as a local motion vector;
(B) calculating a block weight as an index of the reliability of a local motion vector associated with each block; and
(C) receiving the local motion vectors and the block weights to estimate a global motion vector as a motion vector common to the blocks included in the image frame, wherein
in step (C), the sum of the products of the differences between the local motion vectors associated with the respective blocks and the global motion vector and the block weights assigned to the respective blocks subjected to difference calculation is calculated as a cost, configuration parameters of the global motion vector which minimize the cost are calculated, and the global motion vector in which the calculated parameters are set is generated.

7. The method according to claim 6, wherein in step (B), a plurality of block-associated weight data elements based on different data elements are obtained and a block weight associated with each block is calculated on the basis of the block-associated weight data elements.

8. The method according to claim 6, wherein in step (B), a plurality of block-associated weight data elements based on different data elements are obtained and the product of the block-associated weight data elements is calculated as a block weight associated with each block.

9. The method according to claim 6, wherein in step (B), a process for calculating a block weight is performed using at least one of the following values:
(a) the size of a local motion vector associated with each block;
(b) the sum of absolute difference associated with each block;
(c) a variance of pixel values associated with each block;
(d) a covariance obtained from pixel values associated with each block of a processing target frame and those associated with the corresponding block of a reference frame;
(e) a correlation between a local motion vector associated with each block and those associated with blocks adjacent to the block; and
(f) a correlation coefficient obtained from the pixel values associated with each block of the processing target frame and those associated with the corresponding block of the reference frame.

10. The method according to claim 6, wherein in step (C), the local motion vectors and the block weights are received and a single global motion vector associated with the image frame is estimated as a motion vector common to all of the blocks included in the image frame.

11. A computer program that allows an image processing apparatus to execute motion vector detection, the program comprising the steps of:
(A) estimating a motion vector associated with each of blocks, serving as segments of an image frame constituting a moving image, as a local motion vector;
(B) calculating a block weight as an index of the reliability of a local motion vector associated with each block; and
(C) receiving the local motion vectors and the block weights to estimate a global motion vector as a motion vector common to the blocks included in the image frame, wherein
in step (C), the sum of the products of the differences between the local motion vectors associated with the respective blocks and the global motion vector and the block weights assigned to the respective blocks subjected to difference calculation is calculated as a cost, configuration parameters of the global motion vector which minimize the cost are calculated, and the global motion vector in which the calculated parameters are set is generated.
